(19) United States
(12) Patent Application Publication
(10) Pub. No.: US 2020/0017369 A1
(43) Pub. Date: Jan. 16, 2020

(54) Method to Upgrade Titania Concentrates and Slags

(71) Applicant: Salustio Guzman, Saint Bruno (CA)

(72) Inventor: Salustio Guzman, Saint Bruno (CA)

(21) Appl. No.: 16/458,375

(22) Filed: Jul. 1, 2019

Related U.S. Application Data
(60) Provisional application No. 62/696,468, filed on Jul. 11, 2018.

(51) Int. Cl. C01G 23/047

(52) U.S. Cl. CPC C01G 23/047

(57) ABSTRACT

A method is disclosed including: (a) use of sized respectively, ilmenite concentrates and leucoxene concentrates with less than 20% weight of minus 100 microns and titania slags in the 75 to 850 micron range containing minor alkaline oxides within the market limits for chloride TiO2 feedstocks; (b) oxidizing respectively the sized, ilmenite concentrates, leucoxene concentrates and titania slags by contacting with and oxygen containing gas at the temperature of at least of 850° C. for a period of at least 1.5 hours such that, a substantial portion of iron oxide are converted to the ferric state; (c) reducing respectively, the oxidized ilmenite concentrates, oxidized leucoxene concentrates and oxidized titania slags in a reducing atmosphere at a temperature of at least about 1150° C. for a period of at least 1 hour such that the ferric state iron oxides are converted to the “metallic iron” state; (d) Chlorination respectively, of the resulting oxidized and subsequently reduced—namely treated, ilmenite concentrates, leucoxene concentrates and titania slags at a temperature of at least about 800° C., for a period of at least about 1 hour; (e) washing in water and drying respectively, the “Upgraded chlorinated ilmenite concentrates, Upgraded chlorinated leucoxene concentrates and Upgraded chlorinated titania slags”. The method produces respective products with high TiO2 content suitable for the chloride process of TiO2 pigment production and, ferric chloride condensate By-product suitable for the waste water and water treatment industry.

### FIELD OF THE INVENTION

This invention relates to a method of preparing a high grade titanium dioxide—TiO2 product respectively, from sized: ilmenite concentrates, leucoxene concentrates and titania slags by removing iron values usually found in ilmenite concentrates, leucoxene concentrates and titania slags. The present invention generally comprises but is not limited to oxidizing at high temperatures respectively, sized ilmenite concentrates, sized leucoxene concentrates and sized titania slags, reducing respectively at high temperatures the oxidized materials, for a subsequent chlorination at high temperatures respectively, of the reduced materials to yield respectively, “Upgraded Ilmenite Concentrates”, “Upgraded Leucoxene Concentrates” and “Upgraded Titania Slags” and simultaneously, generate a common and similar “Ferric Chloride By-product” for each before mentioned upgraded titania product processed. The respective Upgraded Ilmenite Concentrates, Upgraded Leucoxene Concentrates and Upgraded Titania slags obtained from this invention method which are respectively, suitable feedstock for TiO2 pigment production by the chloride process, titanium sponge production by the Kroll process, welding rods production and, the Ferric Chloride By-product obtained from this invention method can be a suitable chemical additive for sale to the existing market of water (sewage, waste water and potable water treatment) treatment industry and feedstock for the production of iron inorganic pigments.

### DESCRIPTION OF RELATED ART

Titanium dioxide—TiO2 is usually found in nature in ores of ilmenite containing from 30% to 65% TiO2, typically associated with varying quantities of other oxide impurities of the elements of iron, aluminum, silicon, chrome, manganese, calcium, magnesium, vanadium, niobium, phosphorous, sulfur and others. Current conventional mining and mineral beneficiation industrial practices of ilmenite ores yield natural: ilmenite concentrates, leucoxene concentrates and rutile concentrates commercial products used as feedstocks for the production of TiO2 pigment by the sulfate process or the chloride process. Natural ilmenite concentrates are upgraded by the following commercial processes: 1. Smelting Process, for lower TiO2 ilmenite concentrates (35% to 52% TiO2) to yield TiO2 rich slags (˜80% TiO2 sulfate slag, ˜85% TiO2 chloride slag and ˜90% to 91% TiO2 chloride slag), 2. Becher Process, for higher TiO2 ilmenite concentrates (57% to 63% TiO2) to yield “Synthetic Rutile” (90% to 94% TiO2), 3. Benilite Process, for higher TiO2 ilmenite concentrates (57% to 60% TiO2) to yield “Synthetic Rutile” (90% to 94% TiO2), 4. UGS Process, for sulfate slags (˜85% TiO2) to yield “Upgraded Chloride Slag” (˜94% TiO2) they all are commercial products used as feedstocks for the production of TiO2 pigment by the sulfate process or the chloride process. The dusts and/or residues generated by the Smelting, Becher, Benilite and UGS processes are not sold and have a tangible negative cost for abating/mitigating their potential environmental impact, disposal, and/or storage in compliance with the prevailing environmental norms and regulations for the locations where those processes are practiced and, only the iron by-product generated by the Smelting Process is sold as pig iron or further processed to yield commercial products of iron and steel.

### PRIOR ART PROCESSES

The literature mentions a number of processes to upgrade titania concentrates (for example U.S. Pat. Nos. 5,885,324A, 3,457,037 and others) and slags (for example U.S. Pat. No. 6,803,024B1, U.S. Pat. No. 5,830,420 and others) into high grade TiO2 products suitable as feedstocks for the production of TiO2 pigment product via the chloride process however, the key difference of these processes from the proposed process, where Fe metallic is removed by chlorination with chlorine gas without reducing agent, is the practice of atmospheric or pressure leaching stage (in HCl, H2SO4, NH4Cl or FeCl3 solutions) for removing iron reduced respectively to FeO or to Fe metal, after the initial ilmenite oxidation to convert FeO to Fe2O3 including, the Benilite Process (U.S. Pat. No. 3,825,419) and Becher Process (A.P. 56,550/60), two industrial processes practiced presently, consequently they are not discussed beyond this allusion.

E.P. 0234807A2, Glasser, assigned to E.I. DUPONT DE NEMOURS AND COMPANY (today Chemours Company) describes a process for the upgrading of ilmenite by contacting ilmenite ore with a reducing agent at elevated temperatures; continuously cycling a part of the partially reduced ore to a chlorinating zone where it is partially chlorinated in an atmosphere substantially free of carbon and then recycled to the reducing zone; withdrawing the resulting TiO2 beneficiated and FeCl3 vapor to produce Cl2 gas and Fe2O3 waste stream; and recycling the Cl2 gas to the chlorinating zone. The key difference is that, the ferric oxide by design is partially reduced to FeO or 50/50 FeO/Fe metal, instead of total reduction of ferric oxide to Fe metal as in the current proposed process.

(U.S. Pat. No. 2,747,987, Daubenspeck, assigned to National Lead Company and) U.S. Pat. No. 4,629,607, Gueguin, describes a process for the upgrading of chloride slag by contacting the pre-heated slag with pre-heated chlorine gas at elevated temperatures (800 C-950 C) in absence of oxygen resulting in TiO2 beneficiated slag and FeCl3 vapor. The key difference is that iron is present in the slag as FeO and traces of Fe metallic (produced during ilmenite smelting), instead of total reduction of ferric iron to Fe metal as in the current proposed process.

### SUMMARY OF THE INVENTION

The present invention provides a process intended to upgrade the TiO2 values by removing impurities respectively from: ilmenite concentrates, leucoxene concentrates and titania slags. Another way to generally describe the inventive process is a method to increase the TiO2 content respectively in, ilmenite concentrates, leucoxene concentrates and titania slags effecting a pretreatment respectively on, the ilmenite concentrates, leucoxene concentrates and titania slags to provide respectively an, intermediate product which is more easily and selectively removed by Chlorination of its impurities.

In general terms, the present invention provides a method to upgrade TiO2 values respectively in, ilmenite concentrates, leucoxene concentrates and titania slags to obtain respectively, “Upgraded Ilmenite Concentrates”, “Upgraded Leucoxene Concentrates”, “Upgraded Titania Slags” suitable for commercial use as a feedstock in the chloride process for TiO2 pigment production and, a common and similar Ferric Chloride By-product suitable chemical additive for sale to the existing market of water (sewage, waste water and potable water treatment) treatment industry.
(a) Use respectively of sized: ilmenite concentrates and leucoxene concentrates with less than 20% weight of minus 100 microns and titania slags in the 75 to 850 micron range;
(b) Oxidizing respectively the sized: ilmenite concentrates, leucoxene concentrates and titania slags by contacting with and oxygen containing gas at the temperature of at least of 850° C. for a period of at least 1.5 hours such that, a substantial portion of iron oxide are converted to the ferric state;
(c) Reducing respectively, the oxidized: ilmenite concentrates, oxidized leucoxene concentrates and oxidized titania slags in a reducing atmosphere at a temperature of at least about 1150° C. for a period of at least 1 hour such that the ferric state iron oxides are converted to the “metallic iron” state;
(d) Chlorination respectively, of the resulting oxidized and subsequently reduced—namely treated: ilmenite concentrate, leucoxene concentrate and titania slags at a temperature of at least about 800° C., for a period of at least about 1 hour;
(e) Washing in water and drying respectively, the “Upgraded chlorinated ilmenite concentrate, Upgraded chlorinated leucoxene concentrate and Upgraded chlorinated titania slags”.

The method of the present invention consequently removes iron oxide originally contained respectively in: ilmenite concentrates, leucoxene concentrates and titania slags. Preferably the corresponding Upgraded ilmenite concentrate, Upgraded leucoxene concentrate and Upgraded titania slag will contain at least 90% TiO2.

It is also important to note that the treatment during unit steps (b) Oxidation and (c) Reduction also create and increase (in addition to weathering porosity) the “interconnected porosity/micro flaws and channels to the outer surface face” of ilmenite and leucoxene particles and, for titania slags (initially dense particles with no weathering porosity) unit steps (b) Oxidation and (c) Reduction “create” the “interconnected porosity/micro flaws and channels to the outer surface face” of the slag particles.

### BRIEF DESCRIPTION OF THE DRAWINGS

Preferred embodiments of the invention is described by way of example only and with reference to the accompanying drawings wherein:

FIG. 1 shown on page 15 is a simplified flowgram but not limited to the method of the present invention.

### DETAILED DESCRIPTION OF THE INVENTION

The process of the invention comprises but is not limited to four basic unit steps namely:
i. Oxidation respectively of sized: ilmenite concentrates, leucoxene concentrates and titania slags
ii. Reduction respectively of oxidized: ilmenite concentrates, leucoxene concentrates and titania slags
iii. Chlorination respectively of the oxidized and reduced: ilmenite concentrates, leucoxene concentrates and titania slags to yield respectively products of: upgraded ilmenite concentrates, upgraded leucoxene concentrates and upgraded titania slags and simultaneously, a common and similar “Ferric Chloride By-product” for each before mentioned upgraded titania products processed.
iv. Washing and drying respectively of the: upgraded ilmenite concentrates product, leucoxene concentrates product and upgraded titania slags product.

The process may also comprise an optional calcination unit step immediately after the unit step iv.

The respective upgraded ilmenite concentrates, upgraded leucoxene concentrates and upgraded titania slags product of such process will have a high TiO2 content and may be used as feedstock for the TiO2 pigment production by the chloride process, titanium sponge production and welding rods industry.

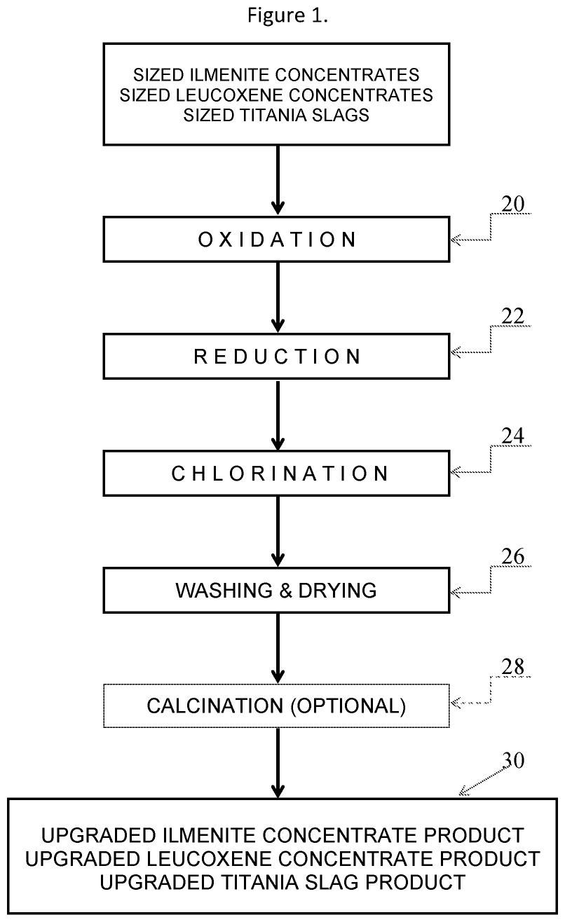

Referring to FIG. 1, it shows that the method of the present invention comprises but not limited to four basic unit steps and an optional unit step described now in more detail.

### Unit Step 1

Numeral 20 on FIG. 1 is an oxidation respectively of, ilmenite concentrates, leucoxene concentrates and titania slags by contacting respectively said, ilmenite concentrates, leucoxene concentrates and titania slags with an oxidizing agent at an elevated temperature of at least about 850° C. To assure uniform exposure respectively of said, ilmenite concentrate, leucoxene concentrate and titania slag particles to the oxidizing gas, intimate solid particles-gas contact and even temperature in the mixture of solid particles and gas system, a fluid bed configuration is preferred but alternatively a rotary kiln or a static—bed systems configuration can also be used. During oxidation, retention times up to at least one hour and a half (1.5 hrs) are sufficient to transform the ferrous iron oxide (Fe+2) to ferric iron oxide (Fe+3) accompanied by, an extensive rutilization of the Ti—Fe—O known mineral phases (Ulvospinel, ilmenite, ferrobrookite and pseudobrookite) present in varying amounts or some of them absent respectively in the initial untreated: ilmenite concentrates, leucoxene concentrates and titania slags

The oxidizing agent will preferably be an oxygen containing gas, containing up to 21% volume of oxygen generated by preheating air or resulting from combustion of a solid, liquid or gaseous fuel in excess of oxygen or air

### Unit Step 2

Numeral 22 on FIG. 1 is a reduction respectively, of the oxidized ilmenite concentrates, oxidized leucoxene concentrates and oxidized titania slags, oxidized in the preceding unit step 1 numeral 20 on FIG. 1, by contacting respectively the oxidized ilmenite concentrates, oxidized leucoxene concentrates and oxidized titania slags with a reducing agent at an elevated temperature of at least about 1150° C. The preferred retention time is at least about 1 hour.

The reducing agent will be advantageously selected from the following, carbon monoxide, hydrogen gas, mixtures thereof, smelting gas, reformed natural gas, charcoal, coal and its derivatives such as coke, fines and other reducing agents known to those skilled in the art. To assure uniform exposure respectively of said oxidized ilmenite concentrate, oxidized leucoxene concentrate and oxidized titania slag particles to the reducing solid or gaseous agent, intimate solid particles gas contact and even temperature in the mixture of solid particles and gas system, a fluid bed configuration is preferred but alternatively a rotary kiln, a short shaft furnace or a static—bed systems configuration can also be used.

Reduction respectively of oxidized ilmenite, oxidized leucoxene concentrates and oxidized titania slags under the above described reducing parameters, temperatures, retention times and reducing agents was found to result in an almost or complete conversion of the ferric oxide (Fe+3) into “metallic iron” (Fe⁰, valence zero 0). These “metallic iron “phase is accessible and exposed to the gas phase.

After unit steps 1 and 2, oxidation and reduction treatment respectively of, ilmenite concentrates, leucoxene concentrates and titania slags, the oxidized and reduced—namely respectively treated ilmenite concentrates, treated leucoxene concentrates and treated titania slags, where the main original mineral phases and oxide constituents of titanium and iron are transformed into rutile—TiO2, and metallic iron—Fe⁰. Because of unit steps 1 and 2, the subsequent chlorination unit step 3 will proceed at enhanced kinetic rates and removal efficiencies.

### Unit Step 3

Numeral 24 on FIG. 1 is a chlorination respectively of the oxidized and subsequently reduced—namely as treated, ilmenite concentrates, leucoxene concentrates and titania slags by contacting respectively said treated, ilmenite concentrates, leucoxene concentrates and titania slags with dry chlorine gas (Cl2) as chlorinating agent at an elevated temperature to selectively chlorinate away the metallic iron and provide a respective solid upgraded products and volatile vapors of ferric chloride as shown in FIG. 1 as numeral 24.

The temperature at which respectively the treated, ilmenite concentrates, leucoxene concentrates and titania slags is contacted with dry chlorine is of at least about 800° C. To assure uniform exposure respectively of said treated, ilmenite concentrate, leucoxene concentrate and titania slag particles to the chlorinating gas chlorine (Cl2), intimate contact of solid particles with chlorine gas and even temperature in the mixture of solid particles and chlorine system, a fluid bed configuration is preferred but alternatively a static—bed systems can also be used. The preferred retention time is at least about 1 hour

Chlorination of the solid metallic iron from respectively oxidized and subsequently reduced-treated, ilmenite concentrates, leucoxene concentrates and titania slags under the above described chlorination parameters, temperatures, retention times with dry chlorine as chlorinating agent was found to result in an almost or complete removal of metallic iron by volatilization of ferric chloride vapors because of the high chemical affinity, high reactivity and fast reaction kinetics of metallic iron for/with dry chlorine gas as, chlorine gas became easily in contact with the “metallic iron” phase present in the ‘treated particles” which is accessible and exposed to chlorine gas via the created and increased (in addition to weathering porosity) “interconnected porosity/micro flaws and channels to the outer surface” of oxidized and reduced—treated, ilmenite and leucoxene particles and, for titania slags (initially dense particles with no weathering porosity) via the “interconnected porosity/micro flaws and channels to the outer surface face” “created” by the oxidization and reduction—treated slag particles.

On unit step 3 shown as numeral 24 on FIG. 1 as Chlorination, the volatilized iron chloride—FeCl3 vapors produced simultaneously to the respective, upgraded ilmenite concentrates, upgraded leucoxene concentrates and upgraded titania slags, can be condensed separately by “spray condensers” to form ferric chloride concentrated solutions (up to 40% wt) to be sold as a product while, the respective solid, upgraded ilmenite concentrates, upgraded leucoxene concentrates and upgraded titania slags goes to the subsequent Unit step 4.

### Unit Step 4

This is the unit step which yields respectively, the solid upgraded products shown as numeral 26 on FIG. 1 where, following the discharge and cooling respectively, the upgraded ilmenite concentrates, upgraded leucoxene concentrates and upgraded titania slags is contacted with water to dissolve away from the solid particles into the aqueous solution all minor amounts of “nonvolatile” chlorides but mostly ferrous chloride formed under the conditions practiced at the “Chlorination” unit step 3 and after drying to drive off the moisture it yields respectively, the upgraded ilmenite concentrates, upgraded leucoxene concentrates and upgraded slags products while, the wash water solution is recycled to the iron chloride “spray condenser”.

### Calcination

In an optional embodiment, the process of the present invention may also comprise a calcination operation shown by the numeral 26 in FIG. 1, in such case the preceding unit step 24 shown in FIG. 1 washing with water only will be needed as the drying practice can become the early stage of the calcination operation, the preferred calcination temperature is at least about 700° C. preferable not above 800° C.

It is to be understood that all the unit steps described above relating to the present invention, may either be conducted in batch or continuous practice mode

### EXAMPLES

The following are illustrative examples, which are set forth by way of illustration and not to be seen as limitations. Batch bench scale test carried out in a muffle electric furnace for the “Oxidation” and, a horizontal electric tube furnace/ceramic tube for the corresponding “Reduction” and “Chlorination”.

### Example 1

The starting material is a commercial sample of sized chloride slag available in the TiO2 feedstock market and sold by the TiO2 feedstock industry to the TiO2 pigment industry for the production of TiO2 pigment by the chloride process. The starting sized chloride slag used has a 850-75 micron size range, typical of chloride slags produced and sold by the TiO2 feedstock industry and having the chemical composition listed below in Table 1.

TABLE 1
Chloride slag composition (% wt)

| TiO2* | Fe ₜ | Fe°ₘ | SiO₂ | Al₂O₃ | CaO | MgO | V₂O₅ | MnO | Cr₂O₅ |
|---|---|---|---|---|---|---|---|---|---|
| 85.10 | 8.70 | 0.20 | 1.56 | 1.09 | 0.16 | 1.01 | 0.41 | 1.73 | 0.20 |

(*total Ti reported as TiO2 regardless of oxidation valence)
(ₜ refers to total iron content regardless of oxidation valence)
(ₘrefers to metallic iron)

The chloride slag was oxidized in the solid state with air at 850° C. for 1.5 hours cooled and reduced at 1150° C. with natural gas (CH4) and nitrogen blanketing gas for 1 hour. After cooling the treated chloride slag was subsequently chlorinated for 1 hour at 800° C. with 100% by volume dry chlorine in excess of the stoichiometric amount required to remove the metallic iron from the treated chloride slag and nitrogen blanketing gas, after cooling the unwashed “upgraded chloride slag” was subjected to conventional chemical analysis techniques. The chemical composition of the resulting upgraded chloride slag product (numerically corrected to account the water washing after chlorination) is listed below in Table 2.

TABLE 2
Upgraded chloride slag product composition (% wt)

| TiO2* | Fe ₜ | Fe°ₘ | SiO₂ | Al₂O₃ | CaO | MgO | V₂O₅ | MnO | Cr₂O₅ |
|---|---|---|---|---|---|---|---|---|---|
| 94.61 | | <1 | 1.93 | 0.91 | 0.21 | 0.70 | 0.17 | 1.12 | 0.35 |

It is also important to note that 2 additional experiments were carried out with the same chloride slag chemical composition shown on Table 1 under the same conditions of Oxidation/Reduction/Chlorination temperature, chlorine gas and retention time indicated above for example 1.

### Example 2

The starting sized chloride slag used has an 850-75 micron size range having the chemical composition listed above in Table 1.

The chloride slag was oxidized in the solid state with air at 850° C. for 1.5 hours cooled and reduced at 1150° C. with charcoal and nitrogen blanketing gas for 1 hour. After cooling the treated chloride slag (containing unremoved excess charcoal due to its finer size) was subsequently chlorinated for 1 hour at 800° C. with 100% by volume dry chlorine in excess of the stoichiometric amount required to remove the metallic iron from the treated chloride slag and nitrogen blanketing gas, after cooling the unwashed “upgraded chloride slag” was subjected to conventional chemical analysis techniques. The chemical composition of the resulting upgraded chloride slag product (numerically corrected to account the water washing after chlorination) is listed below in Table 3.

TABLE 3
Upgraded chloride slag product composition (% wt)

| TiO2* | Fe ₜ | Fe°ₘ | SiO₂ | Al₂O₃ | CaO | MgO | V₂O₅ | MnO | Cr₂O₅ |
|---|---|---|---|---|---|---|---|---|---|
| 93.91 | | <1 | 1.71 | 0.76 | 0.28 | 0.61 | 0.26 | 1.04 | 0.37 |

It is also important to note that 1 additional experiment was carried out with the same chloride slag chemical composition shown on Table 1 under the same conditions of Oxidation/Reduction/Chlorination temperature, chlorine gas and retention time indicated above for example 2.

### Example 3

The starting material is a sample of a commercial sized leucoxene concentrate available in the TiO2 feedstock market and sold by the TiO2 feedstock industry to the TiO2 pigment industry for the production of TiO2 pigment by the chloride process. The starting sized leucoxene concentrate used has a 250-53 micron size range and d₅₀˜130 microns, typical of leucoxene concentrates produced and sold by the TiO2 feedstock industry and having the chemical composition listed below in Table 4

TABLE 4
Leucoxene concentrate composition (% wt)

| TiO2 | Fe ₜ | Fe°ₘ | SiO₂ | Al₂O₃ | CaO | MgO | V₂O₅ | MnO | Cr₂O₅ |
|---|---|---|---|---|---|---|---|---|---|
| 65.80 | 17.560 | | 1.19 | 2.27 | 0.08 | 0.24 | 0.17 | 0.83 | 0.20 |

(ₜ refers to total iron content regardless of oxidation valence)
(ₘrefers to metallic iron)

The leucoxene concentrate was oxidized in the solid state with air at 850° C. for 1.5 hours cooled and reduced at 1150° C. with natural gas (CH4) and nitrogen blanketing gas for 1 hour. After cooling the treated leucoxene concentrate was subsequently chlorinated for 1 hour at 800° C. with 100% by volume dry chlorine in excess of the stoichiometric amount required to remove the metallic iron from the treated leucoxene concentrate and nitrogen blanketing gas, after cooling the unwashed “upgraded leucoxene concentrate” was subjected to conventional chemical analysis techniques. The chemical composition of the resulting upgraded leucoxene concentrate product (numerically corrected to account the water washing after chlorination) is listed below in Table 5.

TABLE 5
Upgraded leucoxene concentrate product composition (% wt)

| TiO2 | Fe ₜ | Fe°ₘ | SiO₂ | Al₂O₃ | CaO | MgO | V₂O₅ | MnO | Cr₂O₅ |
|---|---|---|---|---|---|---|---|---|---|
| 89.30 | | <1 | 2.06 | 4.13 | 0.26 | 0.14 | 0.09 | 0.44 | 0.34 |

It is also important to note that 2 additional experiments was carried out with the same leucoxene concentrate chemical composition shown on Table 4 under the same conditions of Oxidation/Reduction/Chlorination temperature, chlorine gas and retention time indicated above for example 3.

### Example 4

The starting sized leucoxene concentrate used has a 250-53 micron size range and d₅₀ 130 microns having the chemical composition listed above in Table 4

The leucoxene concentrate was oxidized in the solid state with air at 850° C. for 1.5 hours cooled and reduced at 1150° C. with charcoal and nitrogen blanketing gas for 1 hour. After cooling the treated leucoxene concentrate (containing unremoved excess charcoal due to its finer size) was subsequently chlorinated for 1 hour at 800° C. with 100% by volume dry chlorine in excess of the stoichiometric amount required to remove the metallic iron from the treated leucoxene concentrate and nitrogen blanketing gas, after cooling the unwashed “upgraded leucoxene concentrate” was subjected to conventional chemical analysis techniques. The chemical composition of the resulting upgraded leucoxene concentrate product (numerically corrected to account the water washing after chlorination) is listed below in Table 6.

TABLE 6
Upgraded leucoxene concentrate product composition (% wt)

| TiO2* | Fe ₜ | Fe°ₘ | SiO₂ | Al₂O₃ | CaO | MgO | V₂O₅ | MnO | Cr₂O₅ |
|---|---|---|---|---|---|---|---|---|---|
| 91.59 | | <1 | 1.56 | 2.70 | 0.36 | 0.15 | 0.15 | 0.53 | 0.29 |

It is also important to note that 1 additional experiment was carried out with the same leucoxene concentrate chemical composition shown on Table 4 under the same conditions of Oxidation/Reduction/Chlorination temperature, chlorine gas and retention time indicated above for example 4.

The foregoing examples illustrate the method of the present invention can be advantageously applied to upgrade respectively, leucoxene concentrates and chloride slags said method can be also applied successfully to sized ilmenite concentrates and sized sulfate slags.

Although the invention has been described above with respect to one specific form, it will be evident to a person skilled in the art that it may be modified and refined in various ways. It is

1. A method to upgrade respectively, ilmenite concentrates, leucoxene concentrates and titania slags to obtain a high grade TiO2 containing product suitable for use as feedstock for the chloride process practice for the production of titanium dioxide pigment, said respective, ilmenite concentrates, leucoxene concentrates and titania slags containing the Ti—Fe—O known mineral phases (Ulvospinel, ilmenite, ferrobrookite and pseudobrookite) present in varying amounts or some absent also reported as titanium oxides, iron oxides, silicon oxide, aluminum oxide, calcium oxide, magnesium oxide, manganese oxide, chromium oxide, vanadium oxide, phosphorous oxide, niobium oxide and others, the method comprising:
(a) Use of sized respectively, ilmenite concentrates and leucoxene concentrates with less than 20% weight of minus 100 microns and titania slags in the 75 to 850 micron range containing minor alkaline oxides within the market limits for chloride TiO2 feedstocks;
(b) Oxidizing respectively the sized, ilmenite concentrates, leucoxene concentrates and titania slags by contacting with and oxygen containing gas at the temperature of at least of 850° C. for a period of at least 1.5 hours such that, a substantial portion of iron oxide are converted to the ferric state;
(c) Reducing respectively, the oxidized ilmenite concentrates, oxidized leucoxene concentrates and oxidized titania slags in a reducing atmosphere at a temperature of at least about 1150° C. for a period of at least 1 hour such that the ferric state iron oxides are converted to the “metallic iron” state;
(d) Chlorination respectively, of the resulting oxidized and subsequently reduced—namely treated, ilmenite concentrates, leucoxene concentrates and titania slags at a temperature of at least about 800° C., for a period of at least about 1 hour
(e) Washing in water and drying respectively, the “Upgraded chlorinated ilmenite concentrates, Upgraded chlorinated leucoxene concentrates and Upgraded chlorinated titania slags”.

2. A method of claim 1 wherein the resulting respective, upgraded ilmenite concentrate product, upgraded leucoxene concentrate product and upgraded titania slag product contains at least 90% by weight of titanium dioxide and simultaneously, a common and similar “Ferric Chloride By-product” is produced respectively for each before mentioned upgraded titania product.

3. The method of claim 1 wherein Unit step (b) is conducted using air as an oxidizing agent preheated or un-preheated.

4. The method of claim 3 wherein Unit step (b) is conducted in a fluidized bed, rotary kiln or static bed system at a temperature range from about 780° C. to 900° C.

5. The method on claim 3 wherein Unit step (b) is conducted for a period up to 1 hour.

6. The method of claim 1 wherein Unit step (c) is conducted using a reducing agent that includes at least one member or mixtures of selected from the group consisting of carbon monoxide, hydrogen gas, smelter gas, reformed natural gas and coal.

7. The method of claim 6 wherein Unit step (c) is conducted in a fluid bed reactor, rotary kiln or static bed system configuration at a temperature range from 1100° C. to 1350° C.

8. The method of claim 7 wherein Unit step (c) is conducted for a period up to 1 hour.

9. The method of claim 1 wherein the Unit step (d) is conducted with dry chlorine gas preheated or un-preheated.

10. The method of claim 9 wherein Unit step (d) is conducted in a fluidized bed or a static—bed systems configuration at a temperature range of 500° C. to 950° C.

11. The method of claim 10 wherein the Unit step (d) is conducted for a period up to 1 hour.

12. The method in claim 1 wherein Unit step (e) washing the respective upgraded chlorinated ilmenite concentrate, upgraded chlorinated leucoxene concentrate and upgraded chlorinated titania slag product and then dried respectively said upgraded chlorinated ilmenite concentrate, upgraded chlorinated leucoxene and upgraded chlorinated titania slag product.

13. The method of claim 1 conducted in continuous mode as a continuous process.

14. The method of claim 1 conducted in a batch mode as a batch process.
